(19) United States
(12) Patent Application Publication
(10) Pub. No.: US 2014/0366903 A1
(43) Pub. Date: Dec. 18, 2014

(54) Dental Floss And Brush Apparatus

(71) Applicant: Hankookin, Inc., Raleigh, NC (US)

(72) Inventors: James Jiwen Chun, Raleigh, NC (US); Andrew Youngho Chun, Raleigh, NC (US); Angela Soyoung Chun, Raleigh, NC (US); Jennifer Miseong Chun, Raleigh, NC (US)

(21) Appl. No.: 14/301,322

(22) Filed: Jun. 10, 2014

Related U.S. Application Data
(60) Provisional application No. 61/834,421, filed on Jun. 13, 2013.

(51) Int. Cl. A61C 15/04

(52) U.S. Cl. CPC A61C 15/046
USPC 132/200; 132/323; 132/325

(57) ABSTRACT

A dental floss and brush apparatus includes a handle, an arcuate head member including a first arcuate arm and a second arcuate arm, a flossing assembly, and an interdental cleaning member including a flossing element and brush bristles. The flossing assembly includes an elongate channel to accommodate and allow traversal of the flossing element, and a spool member to wind and rotate the flossing element for the traversal of the flossing element through the elongate channel. The flossing element supported between two tubular members dislodges interdental substances in an oral cavity. The brush bristles create a diverging extension arm of a wide dimension towards the first arcuate arm to brush away the dislodged interdental substances from a buccal side of teeth, and another diverging extension arm of a narrow dimension towards the second arcuate arm to brush away the dislodged interdental substances from a lingual side of the teeth.

### CROSS REFERENCE TO RELATED APPLICATIONS

This application claims priority to and the benefit of provisional patent application No. 61/834,421 titled “Dental Floss And Brush Apparatus”, filed in the United States Patent and Trademark Office on Jun. 13, 2013. The specification of the above referenced patent application is incorporated herein by reference in its entirety.

### BACKGROUND

Flossing of teeth is an important part of oral hygiene. Flossing removes plaque and debris from interdental areas in an oral cavity. Conventional devices for flossing comprise a dental floss in a frame that is used to floss teeth including the back teeth in the oral cavity, where a rear end of the frame is used as a toothpick. Although conventional devices for flossing teeth dislodge the plaque and the debris from the interdental areas, they do not brush away the dislodged plaque and debris. In some cases, for example, where the spacing between the teeth of the user is larger than normal, interdental brushes are required for cleaning the interdental areas. However, the interdental brushes do not clean contact areas between the teeth as thoroughly as dental floss. The shape of each tooth and the space between adjacent teeth also limit the application of interdental brushes in cleaning the contact areas between the teeth. The space between adjacent teeth is called an embrasure. The embrasure facing the buccal side of the teeth is wide and thick, while the embrasure facing the lingual side of the teeth is narrow and thin. Interdental brushes and dental floss have a uniform geometry that does not facilitate the cleaning of contact areas between adjacent teeth due to the difference in the embrasures at the buccal side and the lingual side of the teeth.

Hence, there is a long felt but unresolved need for a combination dental floss and brush apparatus that allows a user to perform a combination of flossing and brushing actions for enhanced cleaning of interdental areas in an oral cavity, and that cleans contact areas between adjacent teeth at the buccal side and the lingual side of the teeth.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The dental floss and brush apparatus disclosed herein addresses the above stated needs for allowing a user to perform a combination of flossing and brushing actions for enhanced cleaning of interdental areas in an oral cavity. The dental floss and brush apparatus disclosed herein comprises a handle, an arcuate head member, and an interdental cleaning member. The arcuate head member is rigidly connected to an upper end of the handle. The arcuate head member comprises arcuate arms configured to define a generally arcuate opening. The interdental cleaning member allows cleaning of interdental areas in the oral cavity. The interdental cleaning member is rigidly connected to the arcuate arms of the arcuate head member across the arcuate opening. The interdental cleaning member comprises one or more filament strands configured to create a flossing element at about a mid-section of the filament strands, and to create filament arms extending in opposing directions from the mid-section of the filament strands to the arcuate arms of the arcuate head member. The flossing element dislodges interdental substances, for example, plaque, debris such as food deposits, etc., that accumulate between the teeth or interdental areas in an oral cavity. In an embodiment, the interdental cleaning member further comprises multiple brush bristles fixedly attached at predetermined positions on the filament arms of one filament strand or multiple filament strands. The brush bristles brush away the dislodged interdental substances from the interdental areas in the oral cavity without abrading the interdental areas.

In an embodiment, the dental floss and brush apparatus comprises a handle, an arcuate head member, a flossing assembly, and an interdental cleaning member. In this embodiment, the dental floss and brush apparatus cleans contact areas between adjacent teeth at a buccal side and a lingual side of the teeth. The arcuate head member is rigidly connected to an upper end of the handle. The arcuate head member comprises a first arcuate arm and a second arcuate arm configured to define a generally arcuate opening. The flossing assembly comprises an elongate channel, a first tubular member, a second tubular member, and a spool member. The elongate channel is internally bored proximal to a periphery of the handle and extends from a first opening positioned at a distal end of the first arcuate arm of the arcuate head member to a second opening positioned at a distal end of the second arcuate arm of the arcuate head member. The elongate channel accommodates and allows a flossing element to traverse the elongate channel. The first tubular member and the second tubular member of the flossing assembly are axially connected to the first opening in the first arcuate arm and the second opening in the second arcuate arm respectively. The first tubular member and the second tubular member house the flossing element for allowing the flossing element to traverse across the arcuate opening from the first opening to the second opening. The spool member is internally positioned proximal to a lower end of the handle. The spool member winds the flossing element around a circumference of the spool member and rotates about a spooling axis for allowing the flossing element to traverse through the elongate channel from the circumference of the spool member to the first opening in the first arcuate arm of the arcuate head member, and then through the first opening and across the arcuate opening to the second opening in the second arcuate arm of the arcuate head member, and subsequently from the second opening to a section of the spool member protruding outside the handle.

The interdental cleaning member is connected to the first arcuate arm and the second arcuate arm of the arcuate head member across the arcuate opening. The interdental cleaning member of this embodiment of the dental floss and brush apparatus comprises the flossing element. The flossing element traverses from the first opening to the second opening across the arcuate opening via the flossing assembly. The flossing element supported between the first tubular member and the second tubular member is configured to dislodge interdental substances in interdental areas in an oral cavity. In this embodiment of the dental floss and brush apparatus, the interdental cleaning member further comprises brush bristles of varying lengths fixedly attached at predetermined positions on the first tubular member and the second tubular member of the flossing assembly. The brush bristles create a diverging extension arm towards each of the first arcuate arm and the second arcuate arm of the arcuate head member. The diverging extension arm towards the first arcuate arm of the arcuate head member is of a generally wide dimension and is configured to brush away the dislodged interdental substances from the buccal side of the teeth without abrading interdental areas in the oral cavity. Similarly, the diverging extension arm towards the second arcuate arm of the arcuate head member is of a generally narrow dimension and is configured to brush away the dislodged interdental substances from the lingual side of the teeth without abrading the interdental areas in the oral cavity.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing carries over to the description of that method step or structure shown by that same numeral in any subsequent drawing herein.

FIG. 1 exemplarily illustrates an isometric view of a dental floss and brush apparatus.

FIG. 2A exemplarily illustrates a perspective view of a programmable multi-strand machine configured to merge and demerge filament strands for creation of a flossing element.

FIG. 2B exemplarily illustrates a perspective view of an embodiment of the programmable multi-strand machine, showing a perforated metal bar configured to align the filament strands.

FIG. 2C exemplarily illustrates a top perspective view of the merged and demerged filament strands forming the flossing element at about the mid-section of the filament strands, created using the programmable multi-strand machine exemplarily illustrated in FIGS. 2A-2B.

FIG. 3A exemplarily illustrates a perspective view showing positioning of the dental floss and brush apparatus in an oral cavity for performing a flossing action.

FIG. 3B exemplarily illustrates an enlarged view of a portion marked A of the dental floss and brush apparatus shown in FIG. 3A, showing positioning of the interdental cleaning member in interdental areas for performing a flossing action.

FIG. 3C exemplarily illustrates a perspective view showing positioning of the interdental cleaning member in the interdental areas for performing a brushing action using brush bristles of the interdental cleaning member.

FIG. 4A exemplarily illustrates an isometric view of an embodiment of the dental floss and brush apparatus, showing the interdental cleaning member with a single filament strand and multiple brush bristles.

FIG. 4B exemplarily illustrates an isometric view of another embodiment of the dental floss and brush apparatus, showing a rubber material attached to a single filament strand for housing brush bristles.

FIG. 5 exemplarily illustrates an isometric view of another embodiment of the dental floss and brush apparatus.

FIG. 6A exemplarily illustrates a cutaway view of the embodiment of the dental floss and brush apparatus shown in FIG. 5.

FIG. 6B exemplarily illustrates an enlarged view of a portion marked B of the embodiment of the dental floss and brush apparatus shown in FIG. 6A.

FIG. 7 exemplarily illustrates a cutaway, exploded view of the embodiment of the dental floss and brush apparatus shown in FIG. 5.

FIG. 8 exemplarily illustrates a cutaway view of the embodiment of the dental floss and brush apparatus shown in FIG. 5, showing traversal of the flossing element when a spool member is rotated.

FIG. 9A exemplarily illustrates a perspective view showing positioning of the embodiment of the dental floss and brush apparatus shown in FIG. 5, in an oral cavity for performing a flossing action.

FIG. 9B exemplarily illustrates an enlarged view of a portion marked C of the embodiment of the dental floss and brush apparatus shown in FIG. 9A.

FIG. 10A exemplarily illustrates a perspective view showing positioning of the embodiment of the dental floss and brush apparatus shown in FIG. 5, for performing a brushing action at a buccal side of the teeth.

FIG. 10B exemplarily illustrates a perspective view showing positioning of the embodiment of the dental floss and brush apparatus shown in FIG. 5, for performing a brushing action at a lingual side of the teeth.

FIG. 11 illustrates a method for flossing and brushing away interdental substances from an oral cavity.

### DETAILED DESCRIPTION OF THE INVENTION

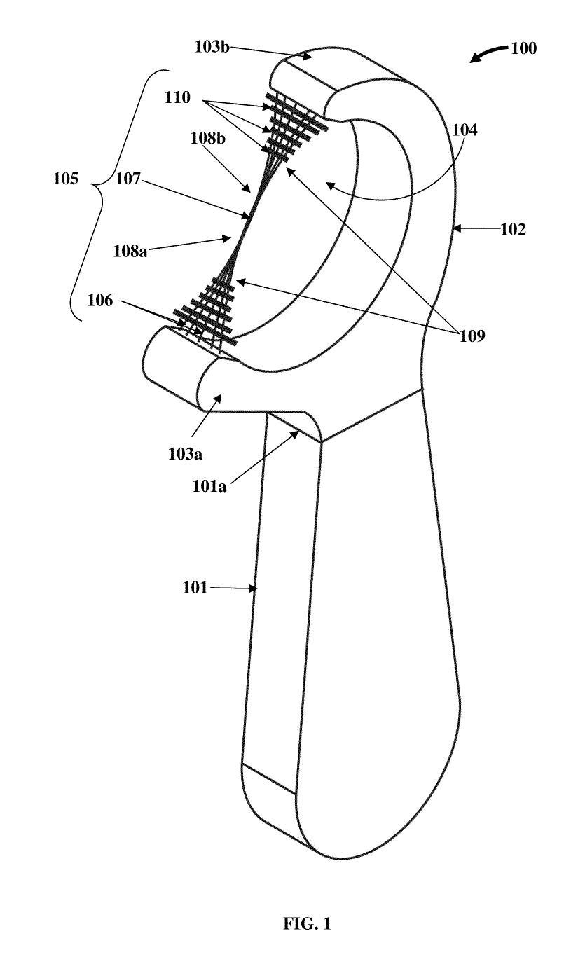

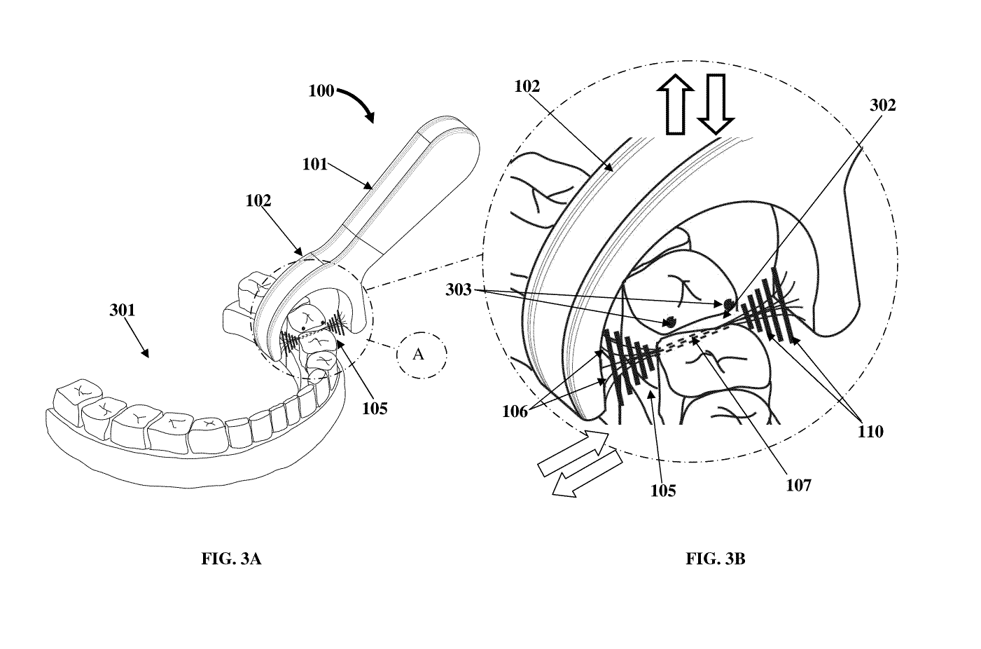

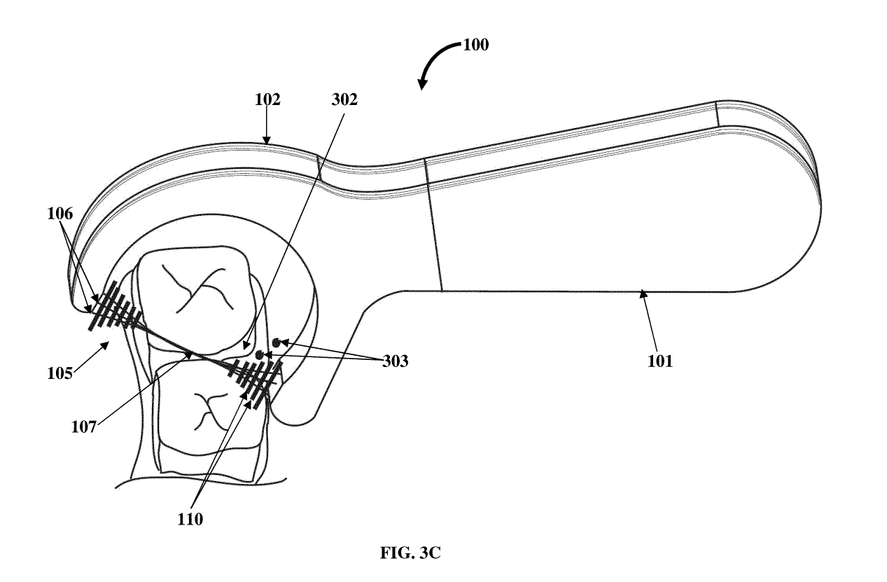

FIG. 1 exemplarily illustrates an isometric view of a dental floss and brush apparatus 100. The dental floss and brush apparatus 100 disclosed herein comprises a handle 101, an arcuate head member 102, and an interdental cleaning member 105. A user holds the dental floss and brush apparatus 100 by the handle 101. The arcuate head member 102 is rigidly connected to an upper end 101a of the handle 101. The arcuate head member 102 and the handle 101 are made of biologically safe and hard plastic materials, for example, polyvinyl chloride, polyethylene, etc. The arcuate head member 102 comprises arcuate arms 103a and 103b configured to define a generally arcuate opening 104, for example, an arched opening. Interdental areas 302 in an oral cavity 301 are cleaned by the interdental cleaning member 105 as exemplarily illustrated in FIGS. 3A-3C. As used herein, “interdental areas” refers to regions between the teeth, gums, etc., where interdental substances 303, for example, plaque, debris, etc., accumulate, as exemplarily illustrated in FIGS. 3A-3C. The interdental cleaning member 105 is rigidly connected to the arcuate arms 103a and 103b of the arcuate head member 102 across the arcuate opening 104 to secure the interdental cleaning member 105.

The interdental cleaning member 105 comprises one or more filament strands 106. One or more filament strands 106 create a flossing element 107 at about a mid-section 108a to 108b of the filament strands 106. In an embodiment, multiple filament strands 106 of the interdental cleaning member 105 extend from a first arcuate arm 103a of the arcuate head member 102 to intertwine and create a single filament strand, that is, a single linear flossing element 107 at about the mid-section 108a to 108b of the filament strands 106, and the single linear flossing element 107 demerges and splits up into the pre-merged multiple filament stands 106 from about the point 108b of the mid-section 108a to 108b of the filament strands 106, which extend towards a second arcuate arm 103b of the arcuate head member 102. The pre-merged and demerged filament strands 106 create filament arms 109 extending in opposing directions from the mid-section 108a to 108b of the filament strands 106 to the arcuate arms 103a and 103b of the arcuate head member 102.

The filament strands 106 are made of different materials, for example, nylon, Teflon® of E.I. du Pont de Nemours and Company Corporation, polyethylene, silk, etc. In an embodiment, the filament strands 106 of the interdental cleaning member 105 are twisted to create a single filament strand forming a single linear flossing element 107 at about the mid-section 108a to 108b of the filament strands 106. In another embodiment, the filament strands 106 of the interdental cleaning member 105 are woven together to create a single filament strand forming a single linear flossing element 107 at about the mid-section 108a to 108b of the filament strands 106. The flossing element 107 at about the mid-section 108a to 108b of the filament strands 106 is used to floss interdental areas 302, for example, the teeth, the gums, etc., in an oral cavity 301 as exemplarily illustrated in FIGS. 3A-3B. The flossing element 107 dislodges interdental substances 303, for example, plaque, debris such as food deposits, etc., located in the interdental areas 302 in the oral cavity 301.

In an embodiment, the interdental cleaning member 105 further comprises multiple brush bristles 110 fixedly attached at predetermined positions on the filament arms 109 of the filament strands 106. The brush bristles 110 are imbedded in the filament arms 109 between fibers of the filament strands 106 in a substantially parallel orientation where each brush bristle 110 is parallel to an adjacent brush bristle 110. The brush bristles 110 are constructed, for example, from nylon filaments, taklon, Teflon®, multi-diameter polyester filaments, etc. In an embodiment, the brush bristles 110 of the interdental cleaning member 105 are twisted between the filament strands 106 for attaching the brush bristles 110 to the filament arms 109 of the filament strands 106. In another embodiment, the brush bristles 110 of the interdental cleaning member 105 are woven with the filament strands 106 for attaching the brush bristles 110 to the filament arms 109 of the filament strands 106. In an embodiment, the brush bristles 110 positioned and attached along the filament arms 109 of the filament strands 106 are constructed from a soft flexible material, for example, a natural rubber material or a synthetic rubber material such as polysiloxane or other silicone rubbers. The flexible material is made of, for example, a soft rubber that is gentle on the interdental areas 302, for example, the teeth, the gums, etc. In an embodiment, the demerge of the filament strands 106 into multiple filament strands 106, followed by the merge into a single filament strand, that is, the flossing element 107 over a mid-section 108a to 108b of the filament strands 106, followed by the demerge of the flossing element 107 into multiple filament strands 106 is performed by a programmable multi-strand machine, for example, a braiding machine, which is well known in the art.

In an embodiment, the brush bristles 110 are made of flexible materials which provide micro massaging and micro irritation on gum tissues, for example, to increase blood flow and improve gum health. The brush bristles 110 brush away the dislodged interdental substances 303 from the interdental areas 302, for example, the teeth, the gums, etc., in the oral cavity 301 without abrading the interdental areas 302. The dental floss and brush apparatus 100 disclosed herein combines flossing and brushing functions for enhanced and convenient cleaning of the interdental areas 302 in less time. The dental floss and brush apparatus 100 exemplarily illustrated in FIG. 1, is a ready to use apparatus with the merged flossing element 107 at the mid-section 108a to 108b and the demerged filament arms 109 extending in opposing directions from the mid-section 108a to 108b, where the interdental cleaning member 105 is discarded after use.

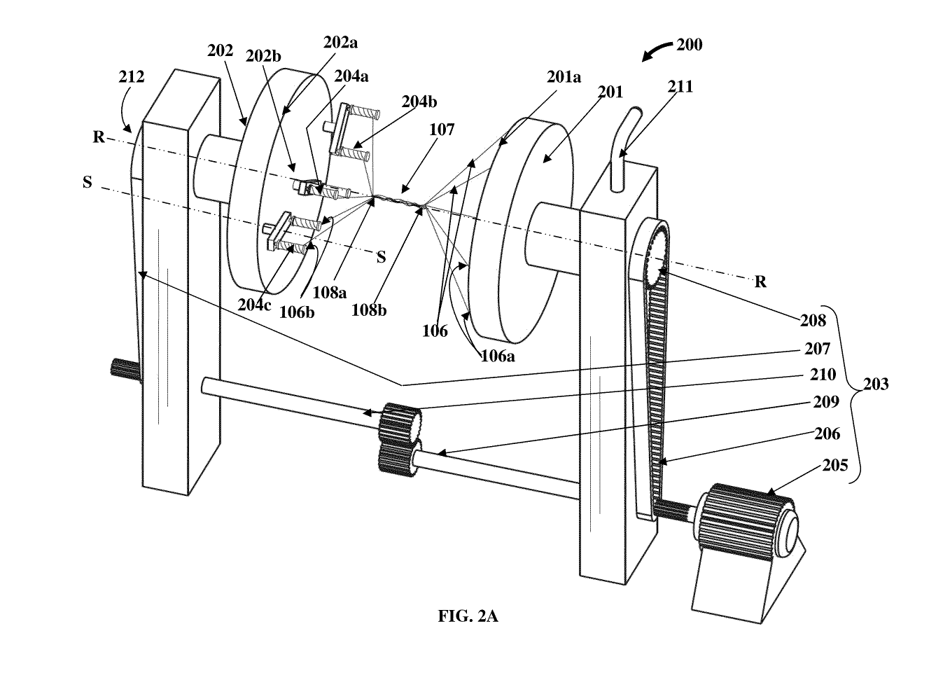

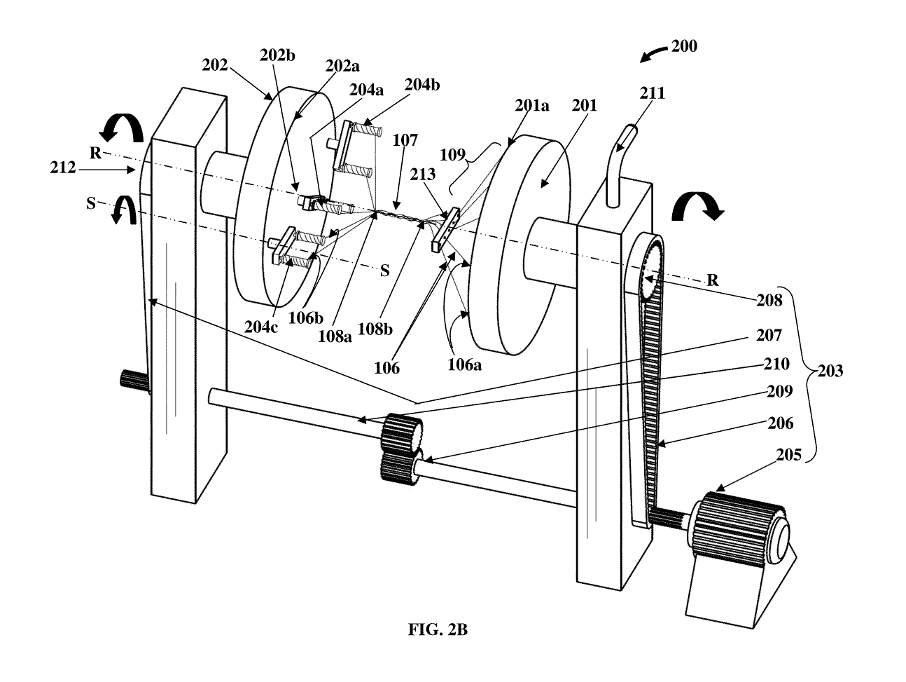

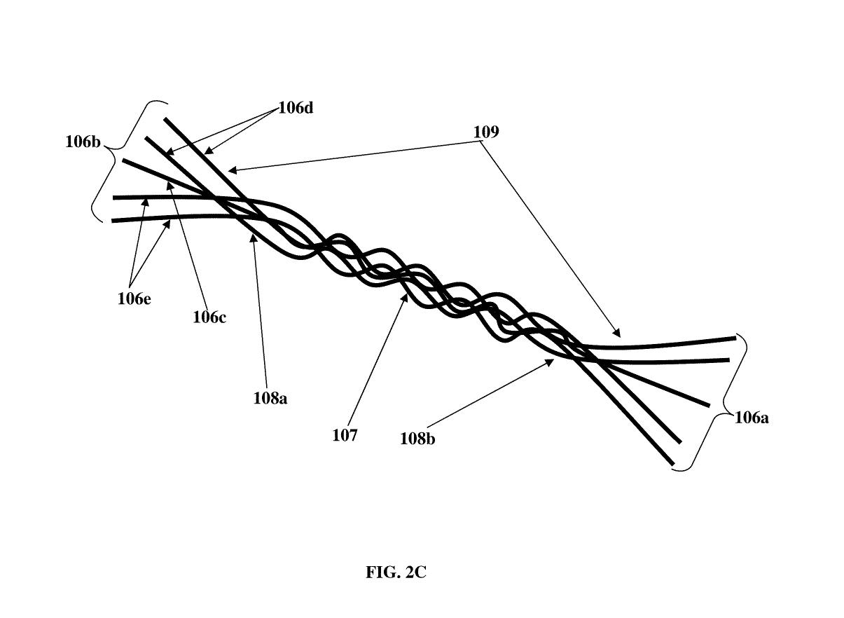

FIG. 2A exemplarily illustrates a perspective view of a programmable multi-strand machine 200 configured to merge and demerge filament strands 106 for creation of a flossing element 107. The programmable multi-strand machine 200 comprises two discs 201 and 202 axially facing each other and operably connected to a rotary assembly 203. The first ends 106a of the filament strands 106 are removably attached proximal to a circumference 201a of the first disc 201. The second ends 106b of the filament strands 106 are connected to paired bobbins 204b and 204c positioned proximal to a circumference 202a of the second disc 202 and a paired bobbin 204a positioned at the center 202b of the second disc 202. The rotary assembly 203 comprises an electric motor 205, a set of belt drives 206 and 207, and a set of drive shafts 208, 209, and 210. The first drive shaft 208 is connected to the first disc 201. The second drive shaft 212 is connected to the second disc 202. The electric motor 205 rotates the first drive shaft 208 via the first belt drive 206 to rotate the first disc 201 in a clockwise direction at low rotations per minute (rpm) about an axis RR. The electric motor 205 simultaneously drives a set of intermediate drive shafts 209 and 210, and a second belt drive 207 to rotate the second drive shaft 212 and in turn the second disc 202 in a counter clockwise direction about the axis RR. Along with the rotation of the first disc 201 and the second disc 202 in opposing directions, the paired bobbins 204a, 204b, and 204c also rotate about an axis SS through an internal gear arrangement, thereby intertwining and merging the filament strands 106 at about the mid-section 108a to 108b of the filament strands 106 to create the flossing element 107. In an embodiment, a clutch lever 211 is operably connected to the first disc 201 to internally disconnect the first disc 201 from the first belt drive 206 and constrain rotation of the first disc 201.

FIG. 2B exemplarily illustrates a perspective view of an embodiment of the programmable multi-strand machine 200, showing a perforated metal bar 213 configured to align the filament strands 106. When a user requires a specific length for the filament arms 109 of the filament strands 106, in this embodiment, a perforated metal bar 213 is positioned between the first disc 201 and the second disc 202 at a predefined distance proximal to the first disc 201. The predefined distance is equal to the specific length required for a filament arm 109. The first ends 106a of the filament strands 106 are removably attached proximal to the circumference 201a of the first disc 201. The second ends 106b of the filament strands 106 are extracted through the perforated metal bar 213 and then connected to the paired bobbins 204a, 204b, and 204c positioned on the second disc 202. The filament arm 109 of the required specific length is locked at the perforated metal bar 213. The filament strands 106 then extend from the perforated metal bar 213 to the paired bobbins 204a, 204b, and 204c positioned on the second disc 202. In this embodiment, the rotation of the first disc 201 is constrained by the clutch lever 211. The second disc 202 is rotated via the rotary assembly 203 to intertwine and merge the filament strands 106 at about the mid-section 108a to 108b of the filament strands 106 to create the flossing element 107. The required length of the filament strands 106 can be machine cut at a later stage.

FIG. 2C exemplarily illustrates a top perspective view of the merged and demerged filament strands 106 forming the flossing element 107 at about the mid-section 108a to 108b of the filament strands 106, created using the programmable multi-strand machine 200 exemplarily illustrated in FIGS. 2A-2B. A single filament strand 106c attached to the paired bobbin 204a at the center 202b of the second disc 202 exemplarily illustrated in FIGS. 2A-2B, intervenes through the pair of filament strands 106d and 106e connected to the paired bobbins 204b and 204c respectively, positioned proximal to the circumference 202a of the second disc 202, to create the flossing element 107 at about the mid-section 108a to 108b of the filament strands 106c, 106d, and 106e. The opposing ends 106a and 106b of the filament strands 106c, 106d, and 106e are injected into the arcuate arms 103a and 103b respectively, of the arcuate head member 102 to create the dental floss and brush apparatus 100 exemplarily illustrated in FIG. 1. A high strength adhesive resin is applied on the arcuate arms 103a and 103b to fixedly attach the opposing ends 106a and 106b of the filament strands 106c, 106d, and 106e to the arcuate arms 103a and 103b respectively.

FIGS. 3A-3C exemplarily illustrate positioning of the dental floss and brush apparatus 100 in an oral cavity 301 for performing flossing and brushing actions. FIG. 3A exemplarily illustrates a perspective view showing the positioning of the dental floss and brush apparatus 100 in an oral cavity 301 for performing a flossing action. The flossing element 107 created by intertwining the filament strands 106 at about the mid-section 108a to 108b of the filament strands 106 as exemplarily illustrated in FIG. 1, is used to floss interdental areas 302 in the oral cavity 301 to dislodge interdental substances 303, for example, plaque, debris such as food deposits, etc., that accumulate between the teeth or in the interdental areas 302. FIG. 3B exemplarily illustrates an enlarged view of a portion marked A of the dental floss and brush apparatus 100 shown in FIG. 3A, showing the positioning of the interdental cleaning member 105 in the interdental areas 302 for performing a flossing action. A user holds the dental floss and brush apparatus 100 by the handle 101 and positions the interdental cleaning member 105 on the interdental areas 302 of the oral cavity 301 as exemplarily illustrated in FIGS. 3A-3B. The user slides the flossing element 107 in the interdental areas 302 in an upward direction and a downward direction and/or in a backward direction and a forward direction to dislodge the interdental substances 303 from the interdental areas 302, as exemplarily illustrated by the arrows in FIG. 3B. FIG. 3C exemplarily illustrates a perspective view showing the positioning of the interdental cleaning member 105 in the interdental areas 302 for performing a brushing action using the brush bristles 110 of the interdental cleaning member 105. As exemplarily illustrated in FIG. 3C, after flossing, the user can brush and remove the dislodged interdental substances 303 from the interdental areas 302 using the brush bristles 110 of the interdental cleaning member 105, without leaving any traces of the interdental substances 303 in the interdental areas 302. The flossing and brushing actions performed using the interdental cleaning member 105 of the dental floss and brush apparatus 100 are repeated for achieving enhanced cleaning of the interdental areas 302.

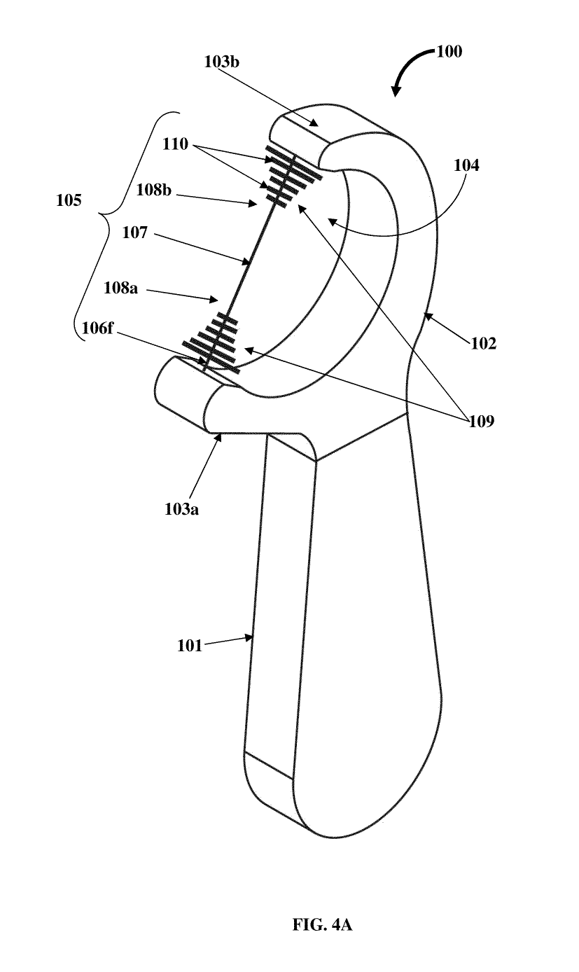

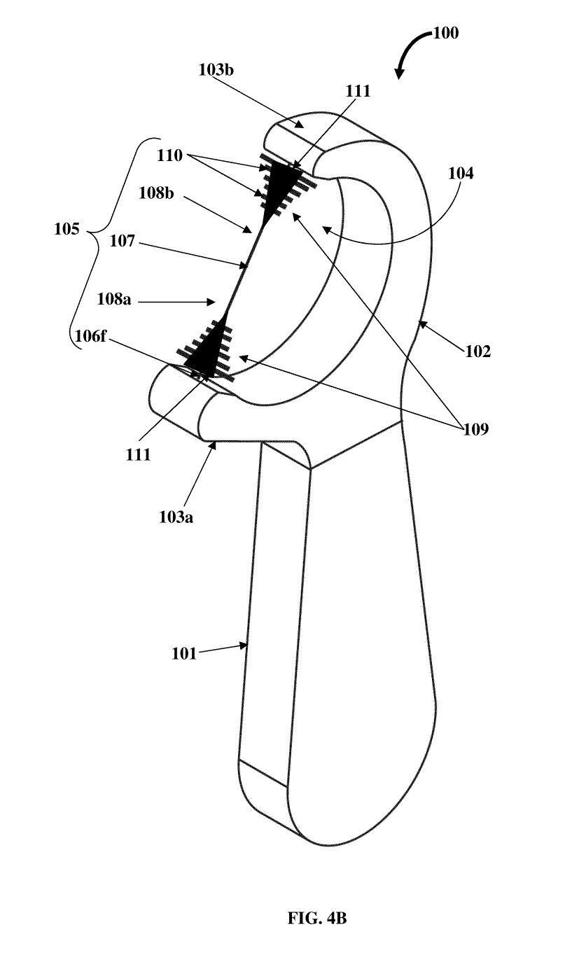

FIG. 4A exemplarily illustrates an isometric view of an embodiment of the dental floss and brush apparatus 100, showing the interdental cleaning member 105 with a single filament strand 106f and multiple brush bristles 110. In the embodiments shown in FIG. 4A through FIG. 10B, the dental floss and brush apparatus 100 has only a single filament strand 106f configured to create a flossing element 107, and not multiple filament strands 106 as exemplarily illustrated in FIG. 1 and FIGS. 3A-3C, intertwined to create the flossing element 107. The filament strands 106 of the interdental cleaning member 105 exemplarily illustrated in FIG. 1 and FIGS. 3A-3C, can be replaced by a single filament strand 106f as exemplarily illustrated in FIG. 4A.

As exemplarily illustrated in FIG. 4A, the interdental cleaning member 105 comprises a single filament strand 106f configured to create a flossing element 107 at about the mid-section 108a to 108b of the filament strand 106f with filament arms 109 distally positioned in opposing directions from about the mid-section 108a to 108b of the filament strand 106f. The brush bristles 110 are positioned substantially parallel to one another and substantially perpendicular to the filament strand 106f on the filament arms 109 of the filament strand 106f. In this embodiment, the brush bristles 110 of the interdental cleaning member 105 are fixedly attached, for example, using glue, at predetermined positions on the filament arms 109 of the single filament strand 106f. The flossing element 107 created at the mid-section 108a to 108b of the single filament strand 106f dislodges interdental substances 303 by movement of the flossing element 107 in an upward direction and a downward direction and/or in a backward direction and a forward direction in the interdental areas 302 in the oral cavity 301 exemplarily illustrated in FIG. 3A. The brush bristles 110 brush away the dislodged interdental substances 303 from the interdental areas 302 without abrading the interdental areas 302.

FIG. 4B exemplarily illustrates an isometric view of another embodiment of the dental floss and brush apparatus 100, showing a rubber material 111 attached to a single filament strand 106f for housing brush bristles 110. In this embodiment, the brush bristles 110 of the interdental cleaning member 105 are infused into a biologically safe rubber material 111 attached on each of the filament arms 109 of the filament strand 106f. The brush bristles 110 are mounted on a biologically safe rubber material 111 such as a soft rubber or a soft silicone rubber fixedly positioned on each of the filament arms 109 of the filament strand 106f to provide gentle contact and comfort to the gum and teeth structure while performing flossing and brushing actions. The brush bristles 110 are infused into the rubber material 111 as the rubber material 111 is molded onto the filament strand 106f. The rubber material 111 or the soft silicone rubber is manufactured, for example, by compression and transfer molding.

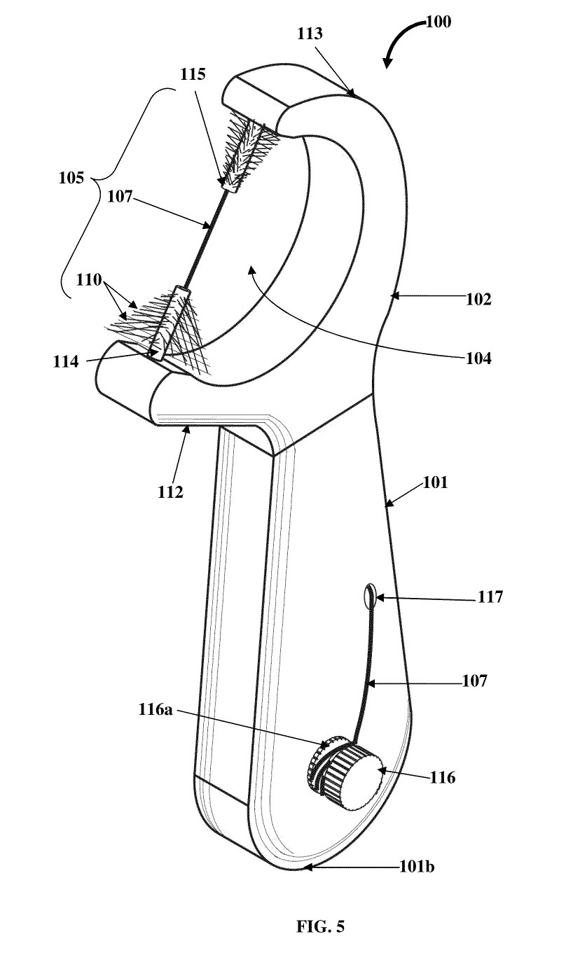

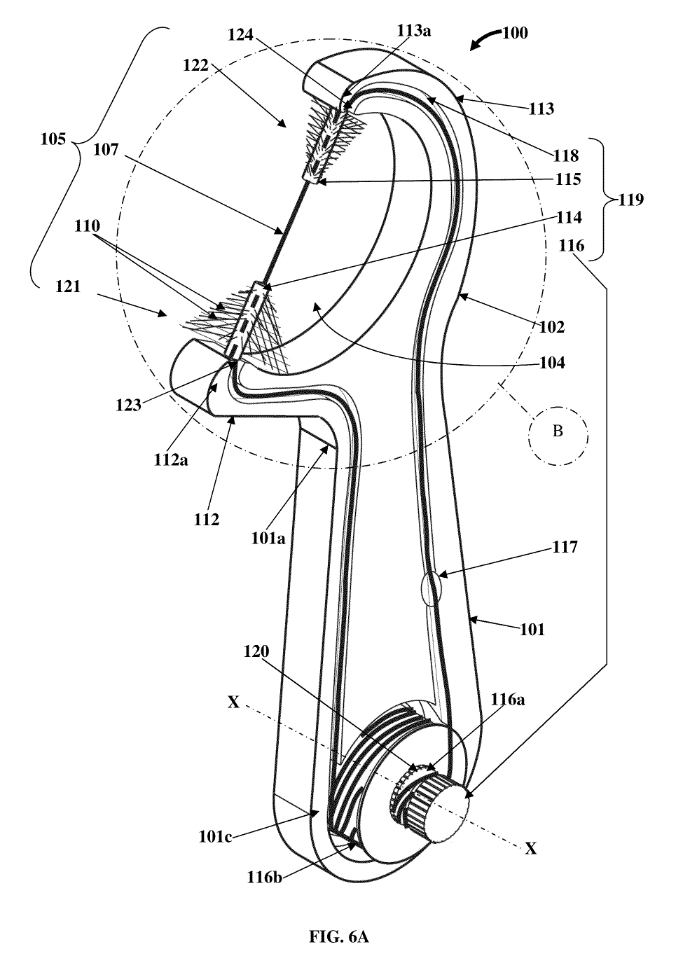

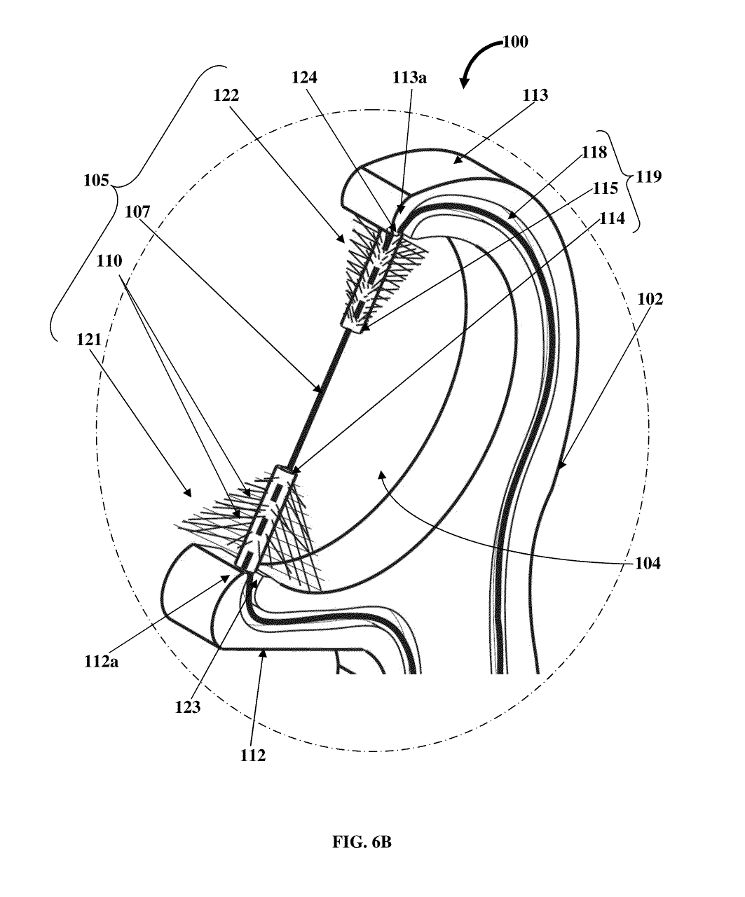

FIG. 5 exemplarily illustrates an isometric view of another embodiment of the dental floss and brush apparatus 100. In this embodiment, the dental floss and brush apparatus 100 disclosed herein comprises a handle 101, an arcuate head member 102, a flossing assembly 119 exemplarily illustrated in FIG. 6A, and an interdental cleaning member 105. The arcuate head member 102 that is rigidly connected to the upper end 101a of the handle 101 comprises a first arcuate arm 112 and a second arcuate arm 113 configured to define a generally arcuate opening 104. The flossing assembly 119 comprises an elongate channel 118 exemplarily illustrated in FIG. 6A, a first tubular member 114 and a second tubular member 115 axially connected to the first arcuate arm 112 and the second arcuate arm 113 of the arcuate head member 102 respectively, and a spool member 116. The elongate channel 118 is internally bored within the handle 101 to accommodate and allow a flossing element 107 to traverse the elongate channel 118. The spool member 116 is internally positioned proximal to a lower end 101b of the handle 101 to wind and store the flossing element 107. The interdental cleaning member 105 comprises the flossing element 107 and, in an embodiment, multiple brush bristles 110. The brush bristles 110 are attached at predetermined positions on the first tubular member 114 and the second tubular member 115 of the flossing assembly 119. An exit opening 117 is positioned on the handle 101 to extract the flossing element 107 from the elongate channel 118 and wind the extracted flossing element 107 on a section 116a of the spool member 116 that protrudes outside the handle 101.

FIG. 6A exemplarily illustrate a cutaway view of the embodiment of the dental floss and brush apparatus 100 shown in FIG. 5, and FIG. 6B exemplarily illustrated an enlarged view of a portion marked B in FIG. 6A. As exemplarily illustrated in FIG. 6A, the elongate channel 118 of the flossing assembly 119 is internally bored proximal to a periphery 101c of the handle 101 and extends from a first opening 123 positioned at a distal end 112a of the first arcuate arm 112 of the arcuate head member 102 to a second opening 124 positioned at a distal end 113a of the second arcuate arm 113 of the arcuate head member 102. The elongate channel 118 accommodates and allows a flossing element 107 to traverse the elongate channel 118.

The dental floss and brush apparatus 100 disclosed herein further comprises an exit opening 117 positioned on the handle 101. The exit opening 117 in communication with the internally bored elongate channel 118 allows the flossing element 107 to be extracted from the elongate channel 118 and wound on a wedge channel 120 configured on the section 116a of the spool member 116 protruding outside the handle 101. The extracted flossing element 107 is wound on the wedge channel 120 in a direction counter to a direction of winding of the flossing element 107 along the circumference 116b of the spool member 116 inside the handle 101. The counter winding of the flossing element 107 inside and outside the handle 101 prevents the spool member 116 from rotating in a backward direction during a flossing action.

As exemplarily illustrated in FIG. 6B, the first tubular member 114 and the second tubular member 115 of the flossing assembly 119 are axially connected to the first opening 123 in the first arcuate arm 112 and the second opening 124 in the second arcuate arm 113 respectively. The first tubular member 114 and the second tubular member 115 house the flossing element 107 for allowing the flossing element 107 to traverse across the arcuate opening 104 from the first opening 123 to the second opening 124. The flossing element 107 advances through the first tubular member 114 and the second tubular member 115. The spool member 116 is internally positioned proximal to a lower end 101b of the handle 101. The spool member 116 winds the flossing element 107 around a circumference 116b of the spool member 116 and rotates about a spooling axis XX for allowing the flossing element 107 to traverse through the elongate channel 118 from the circumference 116b of the spool member 116 to the first opening 123 in the first arcuate arm 112 and then through the first opening 123 and across the arcuate opening 104 to the second opening 124 in the second arcuate arm 113, and subsequently from the second opening 124 to the section 116a of the spool member 116 protruding outside the handle 101.

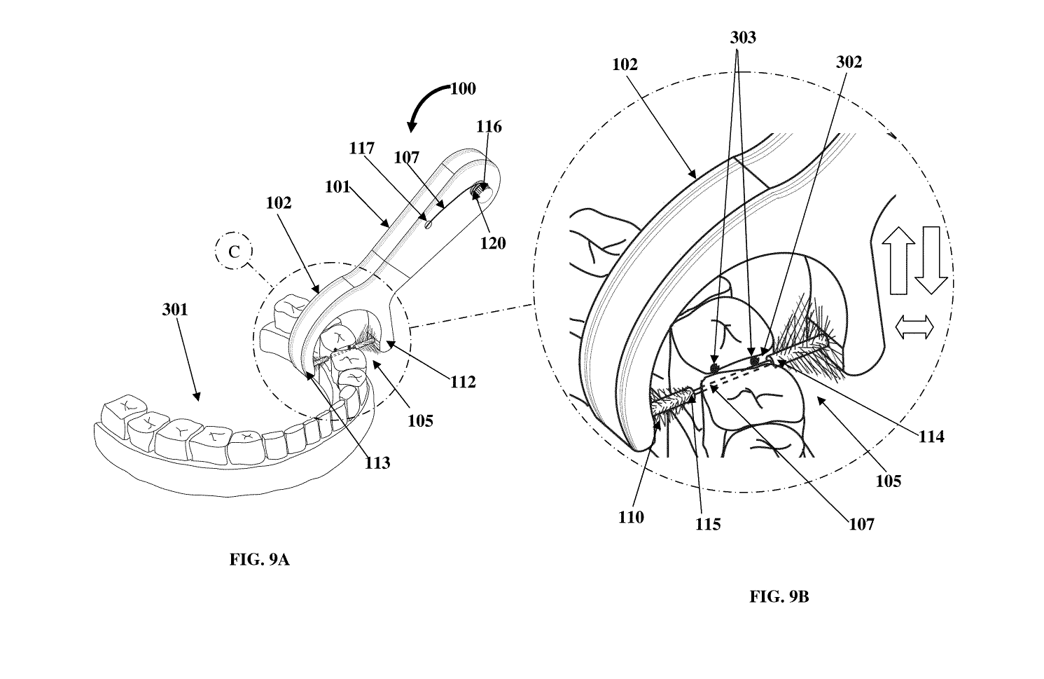

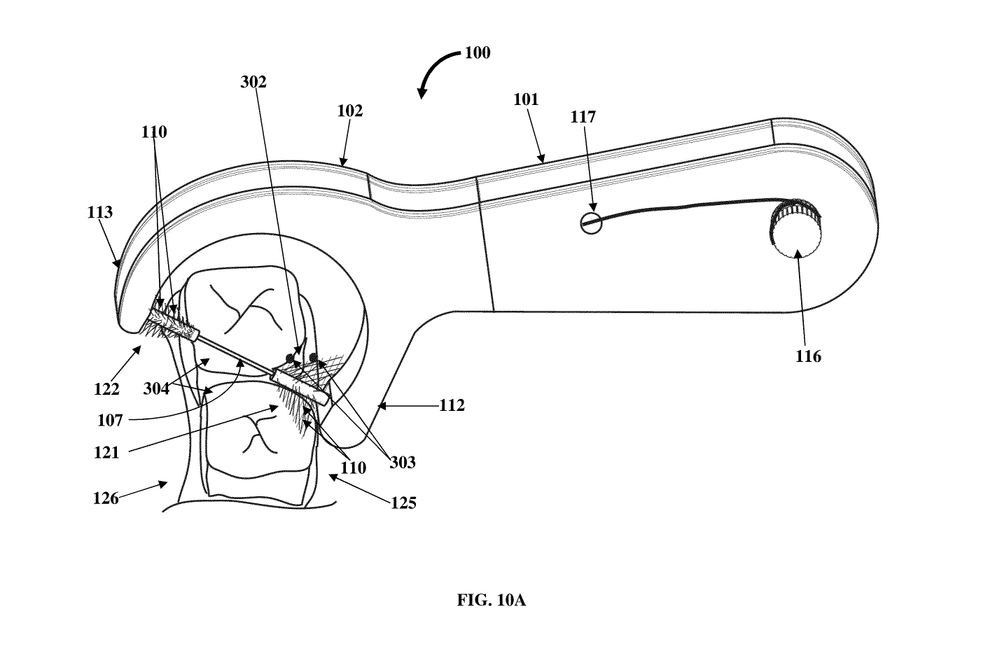

The interdental cleaning member 105 is connected to the first arcuate arm 112 and the second arcuate arm 113 of the arcuate head member 102 across the arcuate opening 104. The interdental cleaning member 105 comprises the flossing element 107. The flossing element 107 traverses from the first opening 123 to the second opening 124 across the arcuate opening 104 via the flossing assembly 119. The flossing element 107 supported between the first tubular member 114 and the second tubular member 115 is configured to dislodge interdental substances 303 in interdental areas 302 in an oral cavity 301 exemplarily illustrated in FIGS. 9A-9B.

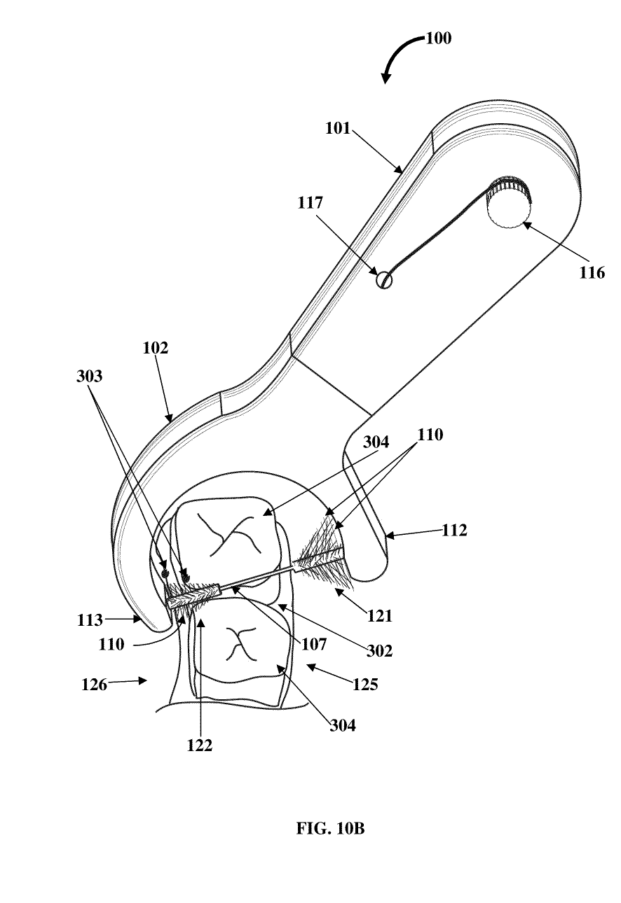

In an embodiment, the interdental cleaning member 105 further comprises multiple brush bristles 110 of varying lengths fixedly attached at predetermined positions on the first tubular member 114 and the second tubular member 115 of the flossing assembly 119. In an embodiment, the brush bristles 110 are cone shaped and form a diverging extension arm 121 towards the first arcuate arm 112 of the arcuate head member 102, and another diverging extension arm 122 towards the second arcuate arm 113 of the arcuate head member 102. The diverging extension arm 121 towards the first arcuate arm 112 of the arcuate head member 102 is of a generally wide dimension for brushing away the dislodged interdental substances 303 from a buccal side 125 of the teeth 304 without abrading interdental areas 302 in the oral cavity 301 as exemplarily illustrated in FIG. 10A. As used herein, “buccal side of the teeth” refers to the side of the teeth 304 that is proximal to the inner surface of the cheek and away from the tongue. The diverging extension arm 122 towards the second arcuate arm 113 of the arcuate head member 102 is of a generally narrow dimension for brushing away the dislodged interdental substances 303 from a lingual side 126 of the teeth 304 without abrading the interdental areas 302 in the oral cavity 301 as exemplarily illustrated in FIG. 10B. As used herein, “lingual side of the teeth” refers to the side of the teeth 304 that is proximal to the tongue and away from the cheek.

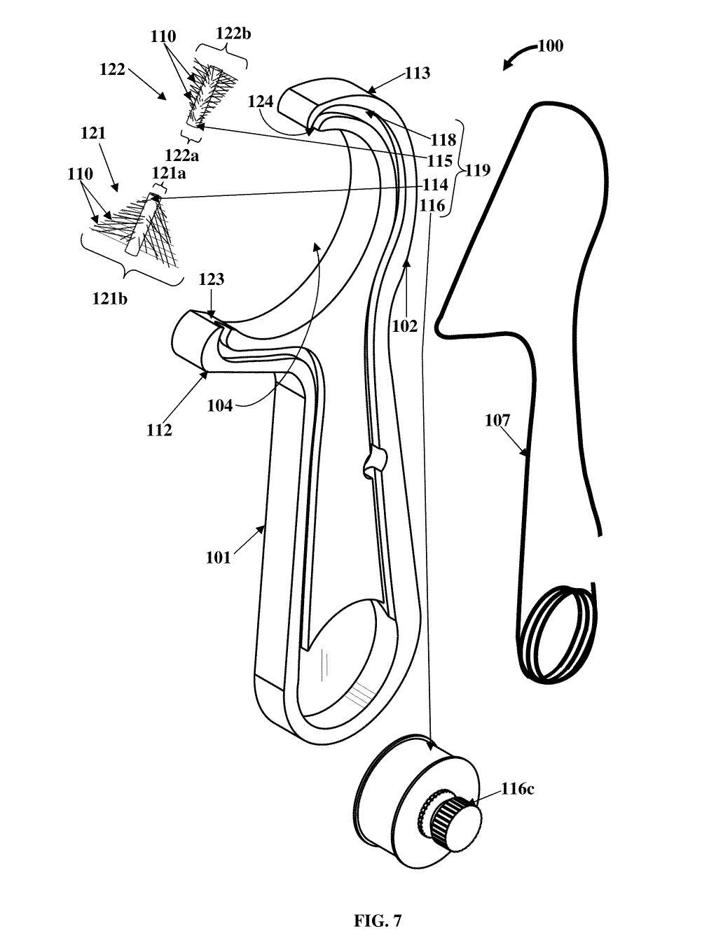

FIG. 7 exemplarily illustrates a cutaway, exploded view of the embodiment of the dental floss and brush apparatus 100 shown in FIG. 5. The dental floss and brush apparatus 100 comprises the handle 101, the arcuate head member 102, and the flossing assembly 119 as disclosed in the detailed description of FIG. 6A. The total height of the dental floss and brush apparatus 100 is, for example, between about 70 millimeters (mm) and about 100 mm, for example, about 80 mm. The average width of the dental floss and brush apparatus 100 is, for example, between about 20 mm and about 60 mm, for example, about 20 mm. The spool member 116 is, for example, a spool wheel with a grip roller 116c to enable a user to grip and roll the spool member 116. The diameter of the spool member 116 is, for example, between about 5 mm and about 9 mm, for example, about 6 mm.

The flossing element 107 is, for example, a long thread made of plastic, polyethylene, nylon, Teflon®, silk, etc. The total length of the flossing element 107 is, for example, between about 15 mm and about 22 mm, for example, about 18 mm. The width of the elongate channel 118 is, for example, between about 0.15 mm and about 1.0 mm, for example, about 0.7 mm. The length of the first tubular member 114 and the second tubular member 115 is, for example, between about 4 mm and about 7 mm, for example, about 5 mm. The average width of the diverging extension arm 121 is, for example, about 2 mm at the narrow end 121a and about 5 mm at the wide end 121b. The average width of the diverging extension arm 122 is, for example, about 1.5 mm at the narrow end 122a and about 3.5 mm at the wide end 122b. The handle 101 and the flossing element 107 are manufactured, for example, by injection molding. The brush bristles 110 or the micro brush bristles are manufactured, for example, by compression and transfer molding.

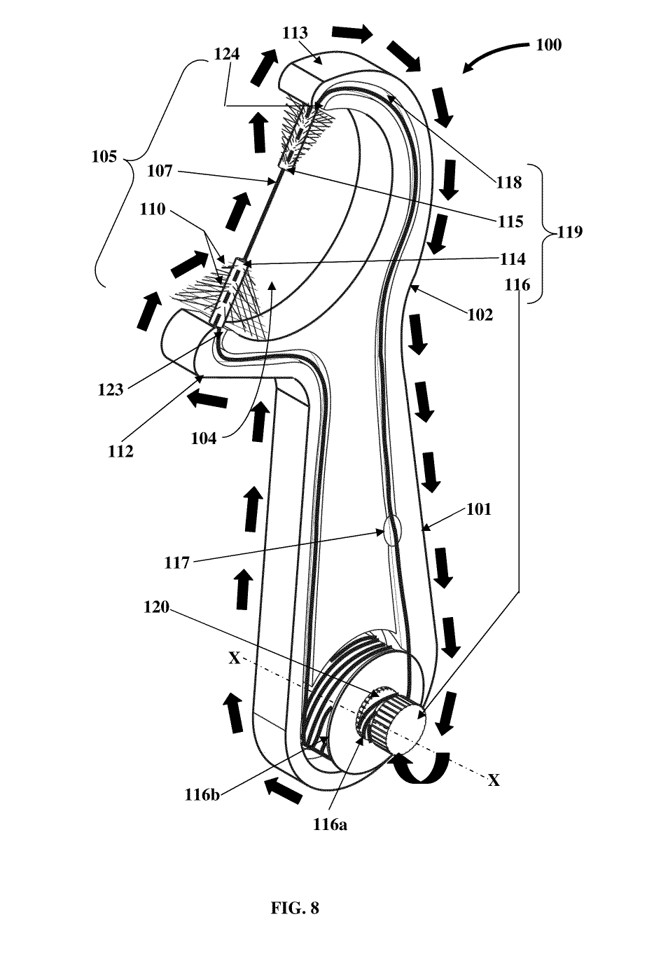

FIG. 8 exemplarily illustrates a cutaway view of the embodiment of the dental floss and brush apparatus 100 shown in FIG. 5, showing traversal of the flossing element 107 when the spool member 116 is rotated. In an embodiment, the spool member 116 of the flossing assembly 119 stores the flossing element 107 of a predetermined length. The spool member 116 is partially rotated to position the flossing element 107 of a predefined length between the first tubular member 114 and the second tubular member 115 of the flossing assembly 119 each time the interdental substances 303 are flossed from the interdental areas 302 in the oral cavity 301 exemplarily illustrated in FIGS. 9A-9B.

When a user rotates the spool member 116 about the spooling axis XX, the flossing element 107 that is wound around the circumference 116b of the spool member 116 traverses from the circumference 116b of the spool member 116 to the first opening 123 in the first arcuate arm 112 of the arcuate head member 102 and then through the first opening 123 and across the arcuate opening 104 to the second opening 124 in the second arcuate arm 113 of the arcuate head member 102, and subsequently from the second opening 124 to the section 116a of the spool member 116 protruding outside the handle 101. The flossing element 107 traverses through a distance corresponding to the rotation of the spool member 116. The arrows shown in FIG. 8 exemplarily illustrate the direction of the traversal of the flossing element 107 when the spool member 116 is rotated. The user rotates the spool member 116 to obtain a new portion of the flossing element 107 between the first tubular member 114 and the second tubular member 115 as disclosed in the detailed description of FIGS. 9A-9B. The used flossing element 107 is extracted from the elongate channel 118 through the exit opening 117. The used flossing element 107 is then wound on the wedge channel 120 of the spool member 116. When the full length of the flossing element 107 from the circumference 116b of the spool member 116 is wound around the wedge channel 120, the flossing element 107 is removed from the wedge channel 120 to be discarded and then a new flossing element 107 is wound around the circumference 116b of the spool member 116, extracted from the elongate channel 118 through the exit opening 117, and wound on the wedge channel 120 of the spool member 116 to start the next flossing cycle.

FIG. 9A exemplarily illustrates a perspective view showing positioning of the embodiment of the dental floss and brush apparatus 100 shown in FIG. 5, in an oral cavity 301 for performing a flossing action. A user initially rotates the spool member 116 to obtain a new portion of the flossing element 107 between the first tubular member 114 and the second tubular member 115 as disclosed in the detailed description of FIG. 8. When the spool member 116 is rotated, the previously used portion of the flossing element 107 is rolled back onto the wedge channel 120 of the spool member 116 and the new portion of the flossing element 107 is positioned between the first tubular member 114 and the second tubular member 115. After the flossing element 107 contacts the interdental areas 302 exemplarily illustrated in FIG. 9B, the used flossing element 107 is threaded out of the handle 101 through the exit opening 117 and wound on the wedge channel 120 of the spool member 116 outside the handle 101. When the flossing element 107 is depleted, a new flossing element 107 is then wound on the circumference 116b of the spool member 116 inside the handle 101, such that the winding of the flossing element 107 on the wedge channel 120 is counter to the direction of winding of the flossing element 107 along the circumference 116b of the spool member 116 to prevent the spool member 116 from rotating backward during the flossing action of the flossing element 107.

FIG. 9B exemplarily illustrates an enlarged view of a portion marked C of the embodiment of the dental floss and brush apparatus 100 shown in FIG. 9A. A user positions the flossing element 107 in the interdental areas 302 of the oral cavity 301 exemplarily illustrated in FIG. 9A, and slides the flossing element 107 in the interdental areas 302 in an upward direction and a downward direction and/or in a backward direction and a forward direction to dislodge interdental substances 303 from the interdental areas 302 as exemplarily illustrated by the arrows in FIG. 9B. The flossing element 107 can be changed after each use or after the flossing element 107 positioned between the first tubular member 114 and the second tubular member 115 of the dental floss and brush apparatus 100 is depleted.

FIGS. 10A-10B exemplarily illustrate perspective showing the positioning of the embodiment of the dental floss and brush apparatus 100 shown in FIG. 5, for performing a brushing action at a buccal side 125 of the teeth 304 and a lingual side 126 of the teeth 304 respectively. The brushing action of the dental floss and brush apparatus 100 depends on the embrasure of the teeth 304, that is, the space between adjacent teeth 304 on the buccal side 125 and the lingual side 126 of the teeth 304. The dental floss and brush apparatus 100 is positioned with the first arcuate arm 112 of the arcuate head member 102 facing the buccal side 125 of the teeth 304, and the second arcuate arm 113 of the arcuate head member 102 facing the lingual side 126 of the teeth 304. The diverging extension arm 121 created by the brush bristles 110 towards the first arcuate arm 112 of the arcuate head member 102 is of a wide dimension for brushing away the dislodged interdental substances 303 from the buccal side 125 of the teeth 304. The diverging extension arm 121 comprises brush bristles 110 with a wide dimension to brush away the dislodged interdental substances 303 from the buccal side 125 of the teeth 304 due to the wide embrasure of the teeth 304 on the buccal side 125. A user inclines the first arcuate arm 112 of the dental floss and brush apparatus 100 to face the buccal side 125 of the teeth 304 as exemplarily illustrated in FIG. 10A, to brush away the dislodged interdental substances 303 from the interdental areas 302 in the oral cavity 301 without abrading the interdental areas 302.

As exemplarily illustrated in FIG. 10B, the diverging extension arm 122 created by the brush bristles 110 towards the second arcuate arm 113 of the arcuate head member 102 is of a narrow dimension for brushing away the dislodged interdental substances 303 from the lingual side 126 of the teeth 304. The diverging extension arm 122 comprises brush bristles 110 with a narrow dimension to brush away the dislodged interdental substances 303 from the lingual side 126 of the teeth 304 due to the narrow embrasure of the teeth 304 on the lingual side 126. A user inclines the second arcuate arm 113 of the dental floss and brush apparatus 100 to face the lingual side 126 of the teeth 304 as exemplarily illustrated in FIG. 10B, to brush away the dislodged interdental substances 303 from the interdental areas 302 in the oral cavity 301 without abrading the interdental areas 302.

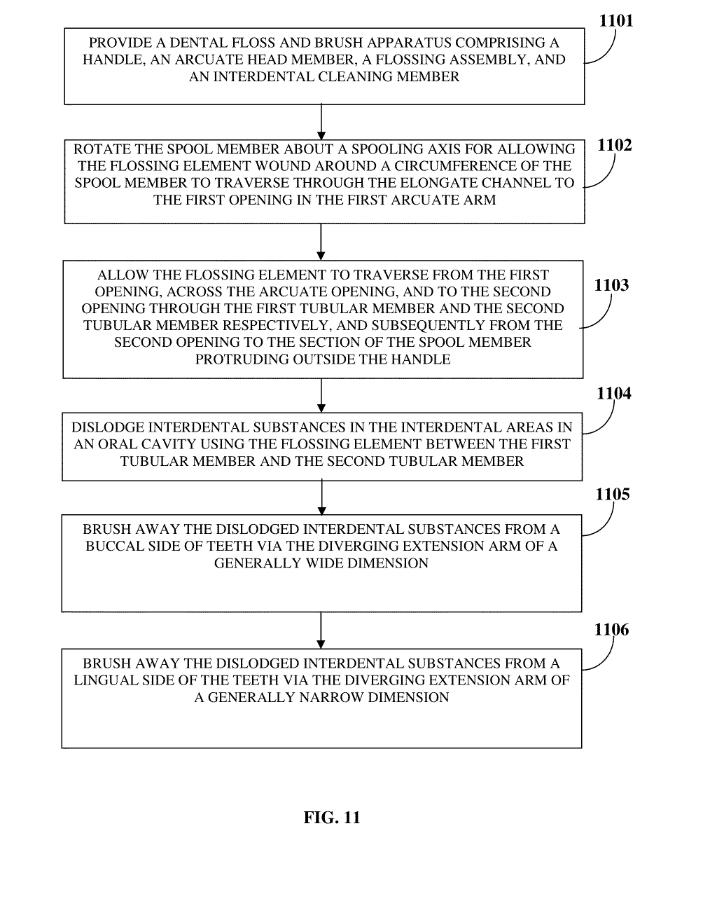

FIG. 11 illustrates a method for flossing and brushing away interdental substances 303 from an oral cavity 301. The dental floss and brush apparatus 100 comprising the handle 101, the arcuate head member 102, the flossing assembly 119, and the interdental cleaning member 105 as disclosed in the detailed description of FIG. 5, FIGS. 6A-6B, FIGS. 9A-9B, and FIGS. 10A-10B, is provided 1101. A user rotates 1102 the spool member 116 of the flossing assembly 119 about a spooling axis XX for allowing the flossing element 107 wound around the circumference 116b of the spool member 116 to traverse through the elongate channel 118 of the flossing assembly 119 to the first opening 123 in the first arcuate arm 112 of the arcuate head member 102. The user allows the flossing element 107 to traverse 1103 from the first opening 123, across the arcuate opening 104 defined by the arcuate arms 112 and 113 of the arcuate head member 102 and to the second opening 124 in the second arcuate arm 113 of the arcuate head member 102 through the first tubular member 114 and the second tubular member 115 of the flossing assembly 119 respectively, and subsequently from the second opening 124 to the section 116a of the spool member 116 protruding outside the handle 101. The user uses the flossing element 107 between the first tubular member 114 and the second tubular member 115 to dislodge 1104 the interdental substances 303 in the interdental areas 302 in the oral cavity 301 by an upward movement, a downward movement, and a sideways movement of the flossing element 107 between the adjacent teeth 304, as shown by the arrows in FIG. 9B. The user brushes 1105 away the dislodged interdental substances 303 from the buccal side 125 of the teeth 304 via the diverging extension arm 121 extending towards the first arcuate arm 112 of the arcuate head member 102, which is of a generally wide dimension. The user brushes 1106 away the dislodged interdental substances 303 from the lingual side 126 of the teeth 304 via the diverging extension arm 122 extending towards the second arcuate arm 113 of the arcuate head member 102, which is of a generally narrow dimension.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A dental floss and brush apparatus comprising:
a handle;
an arcuate head member rigidly connected to an upper end of said handle, said arcuate head member comprising arcuate arms configured to define a generally arcuate opening; and
an interdental cleaning member rigidly connected to said arcuate arms of said arcuate head member across said generally arcuate opening, said interdental cleaning member comprising:
one or more of a plurality of filament strands configured to create a flossing element at about a mid-section of said filament strands, and to create filament arms extending in opposing directions from said mid-section of said filament strands to said arcuate arms of said arcuate head member, wherein said flossing element is configured to dislodge interdental substances in interdental areas in an oral cavity.

2. The dental floss and brush apparatus of claim 1, wherein said plurality of said filament strands of said interdental cleaning member extends from a first of said arcuate arms of said arcuate head member to intertwine and create a single said flossing element at about said mid-section of said filament strands, and wherein said single said flossing element is further configured to demerge and split up into pre-merged said filament stands from about said mid-section of said filament strands and extend towards a second of said arcuate arms of said arcuate head member.

3. The dental floss and brush apparatus of claim 1, wherein said filament strands of said interdental cleaning member are configured to be twisted to create a single filament strand forming a single linear said flossing element at about said mid-section of said filament strands.

4. The dental floss and brush apparatus of claim 1, wherein said filament strands of said interdental cleaning member are configured to be woven together to create a single filament strand forming a single linear said flossing element at about said mid-section of said filament strands.

5. The dental floss and brush apparatus of claim 1, wherein said interdental cleaning member further comprises a plurality of brush bristles fixedly attached at predetermined positions on said filament arms of said one or more of said filament strands, wherein said brush bristles are configured to brush away said dislodged interdental substances from said interdental areas in said oral cavity without abrading said interdental areas.

6. The dental floss and brush apparatus of claim 5, wherein said brush bristles of said interdental cleaning member are attached to said filament arms of said one or more of said filament strands by twisting said brush bristles between said filament strands.

7. The dental floss and brush apparatus of claim 5, wherein said brush bristles of said interdental cleaning member are attached to said filament arms of said one or more of said filament strands by weaving said brush bristles with said filament strands.

8. The dental floss and brush apparatus of claim 5, wherein said brush bristles of said interdental cleaning member are attached to said filament arms of said one or more of said filament strands by infusing said brush bristles into a rubber material configured to be attached on said filament arms of said one or more of said filament strands.

9. The dental floss and brush apparatus of claim 5, wherein said brush bristles are constructed from a soft flexible material.

10. The dental floss and brush apparatus of claim 5, wherein said brush bristles are made of a flexible material configured to provide micro massaging and micro irritation on gum tissues.

11. A dental floss and brush apparatus comprising:
a handle;
an arcuate head member rigidly connected to an upper end of said handle, said arcuate head member comprising a first arcuate arm and a second arcuate arm configured to define a generally arcuate opening;
a flossing assembly comprising:
an elongate channel internally bored proximal to a periphery of said handle and extending from a first opening positioned at a distal end of said first arcuate arm of said arcuate head member to a second opening positioned at a distal end of said second arcuate arm of said arcuate head member, said elongate channel configured to accommodate and allow a flossing element to traverse said elongate channel;
a first tubular member and a second tubular member axially connected to said first opening in said first arcuate arm and said second opening in said second arcuate arm respectively, said first tubular member and said second tubular member configured to house said flossing element for allowing said flossing element to traverse across said generally arcuate opening from said first opening to said second opening; and
a spool member internally positioned proximal to a lower end of said handle, said spool member configured to wind said flossing element around a circumference of said spool member and rotate about a spooling axis for allowing said flossing element to traverse through said elongate channel from said circumference of said spool member to said first opening in said first arcuate arm, and then through said first opening and across said generally arcuate opening to said second opening in said second arcuate arm, and subsequently from said second opening to a section of said spool member protruding outside said handle; and
an interdental cleaning member connected to said first arcuate arm and said second arcuate arm of said arcuate head member across said generally arcuate opening, said interdental cleaning member comprising:
said flossing element traversing from said first opening to said second opening across said generally arcuate opening via said flossing assembly, wherein said flossing element supported between said first tubular member and said second tubular member is configured to dislodge interdental substances in interdental areas in an oral cavity.

12. The dental floss and brush apparatus of claim 11, wherein said interdental cleaning member further comprises a plurality of brush bristles of varying lengths fixedly attached at predetermined positions on said first tubular member and said second tubular member of said flossing assembly, wherein said brush bristles are configured to create a diverging extension arm towards each of said first arcuate arm and said second arcuate arm of said arcuate head member, wherein said diverging extension arm towards said first arcuate arm of said arcuate head member with a generally wide dimension is configured to brush away said dislodged interdental substances from a buccal side of teeth, and wherein said diverging extension arm towards said second arcuate arm of said arcuate head member with a generally narrow dimension is configured to brush away said dislodged interdental substances from a lingual side of said teeth, without abrading said interdental areas in said oral cavity.

13. The dental floss and brush apparatus of claim 12, wherein said brush bristles are cone shaped and configured to form said diverging extension arm towards said first arcuate arm of said arcuate head member and another said diverging extension arm towards said second arcuate arm of said arcuate head member.

14. The dental floss and brush apparatus of claim 11, wherein said spool member of said flossing assembly is further configured to store said flossing element of a predetermined length, wherein said spool member is partially rotated to position said flossing element of a predefined length between said first tubular member and said second tubular member of said flossing assembly each time said interdental substances are flossed from said interdental areas in said oral cavity.

15. The dental floss and brush apparatus of claim 11, further comprising an exit opening positioned on said handle, wherein said exit opening in communication with said internally bored elongate channel of said flossing assembly is configured to allow said flossing element to be extracted from said elongate channel to be wound on a wedge channel of said section of said spool member protruding outside said handle.

16. The dental floss and brush apparatus of claim 15, further comprising said wedge channel configured on said section of said spool member protruding outside said handle, wherein said wedge channel is configured to wind said extracted flossing element in a direction counter to a direction of winding of said flossing element along said circumference of said spool member inside said handle, wherein counter winding of said flossing element inside and outside said handle prevents said spool member from rotating in a backward direction during a flossing action.

17. A method for flossing and brushing away interdental substances from an oral cavity, said method comprising:
providing a dental floss and brush apparatus comprising:
a handle;
an arcuate head member rigidly connected to an upper end of said handle, said arcuate head member comprising a first arcuate arm and a second arcuate arm configured to define a generally arcuate opening;
a flossing assembly comprising:
an elongate channel internally bored proximal to a periphery of said handle and extending from a first opening positioned at a distal end of said first arcuate arm of said arcuate head member to a second opening positioned at a distal end of said second arcuate arm of said arcuate head member, said elongate channel configured to accommodate a flossing element;
a first tubular member and a second tubular member axially connected to said first opening and said second opening respectively, said first tubular member and said second tubular member configured to house said flossing element for allowing said flossing element to traverse across said generally arcuate opening from said first opening to said second opening; and
a spool member internally positioned proximal to a lower end of said handle, said spool member configured to wind said flossing element around a circumference of said spool member; and
an interdental cleaning member connected to said first arcuate arm and said second arcuate arm of said arcuate head member across said generally arcuate opening, said interdental cleaning member comprising:
said flossing element supported by said first tubular member and said second tubular member for allowing said flossing element to traverse across said generally arcuate opening from said first opening to said second opening via said flossing assembly; and
a plurality of brush bristles of varying lengths fixedly attached at predetermined positions on said first tubular member and said second tubular member of said flossing assembly, wherein said brush bristles are configured to create a diverging extension arm towards each of said first arcuate arm and said second arcuate arm of said arcuate head member, wherein said diverging extension arm towards said first arcuate arm of said arcuate head member is of a generally wide dimension, and wherein said diverging extension arm towards said second arcuate arm of said arcuate head member is of a generally narrow dimension;
rotating said spool member of said flossing assembly about a spooling axis for allowing said flossing element wound around said circumference of said spool member to traverse through said elongate channel of said flossing assembly to said first opening in said first arcuate arm of said arcuate head member;
allowing said flossing element to traverse from said first opening in said first arcuate arm of said arcuate head member, across said generally arcuate opening, and to said second opening in said second arcuate arm of said arcuate head member through said first tubular member and said second tubular member of said flossing assembly respectively, and subsequently from said second opening to a section of said spool member protruding outside said handle;
dislodging said interdental substances in said interdental areas in said oral cavity using said flossing element between said first tubular member and said second tubular member by an upward movement, a downward movement, and a sideways movement of said flossing element between adjacent teeth;
brushing away said dislodged interdental substances from a buccal side of teeth without abrading said interdental areas in said oral cavity via said diverging extension arm of said generally wide dimension; and
brushing away said dislodged interdental substances from a lingual side of said teeth without abrading said interdental areas in said oral cavity via said diverging extension arm of said generally narrow dimension.

18. The method of claim 17, wherein said spool member is partially rotated to position said flossing element of a predefined length between said first tubular member and said second tubular member of said flossing assembly each time said interdental substances are flossed from said interdental areas in said oral cavity.

19. The method of claim 17, wherein said dental floss and brush apparatus further comprises:
an exit opening positioned on said handle, wherein said exit opening in communication with said internally bored elongate channel of said flossing assembly is configured to allow said flossing element to be extracted from said elongate channel to be wound on a wedge channel of said section of said spool member protruding outside said handle; and
said wedge channel configured to wind said extracted flossing element in a direction counter to a direction of winding of said flossing element along said circumference of said spool member inside said handle, wherein counter winding of said flossing element inside and outside said handle prevents said spool member from rotating in a backward direction during a flossing action.
